(19) United States
(12) Patent Application Publication
(10) Pub. No.: US 2018/0020855 A1
(43) Pub. Date: Jan. 25, 2018

(54) HEAT INSULATION BOTTLE

(71) Applicant: Jia-Shou WANG, NEW TAIPEI CITY (TW)

(72) Inventor: Jia-Shou WANG, NEW TAIPEI CITY (TW)

(21) Appl. No.: 15/657,609

(22) Filed: Jul. 24, 2017

(30) Foreign Application Priority Data
Jul. 25, 2016 (TW) 105123362

(51) Int. Cl. A47G 19/22; A47J 41/00

(52) U.S. Cl. CPC A47G 19/2288; A47J 41/0083; A47G 19/2222; A47G 19/2205

(57) ABSTRACT

A heat insulation bottle includes a bottle body having an accommodation chamber opened to a top side thereof with a concave arc portion defined in an inner bottom side, a bottle head detachably connected to the bottle body and including a bottle mouth located at a top side with an opening defined therein in communication with the accommodation chamber, a guide surface located at an opposing bottom side thereof and sloping upwards from the bottom side of the bottle head to a bottom side of the opening and an air vent in communication between the accommodation chamber and the outside, a flexible bushing mounted in the opening in the bottle mouth, and a bottle cover connected to the bottle head and adapted for blocking the opening in the bottle mouth. The heat insulation bottle is practical for serving hot drinks, cold drinks and drinks with fruit particles.

### BACKGROUND OF THE INVENTION

1. Field of the Invention

The present invention relates to drinking container technology and more particularly, to an improved structure of heat insulation bottle.

2. Description of the Related Art

With the boom of the current beverage market, a variety of drinks have been launched to the market. For the sake of health and safety, it is good to use heat insulation bottles or thermos flasks for holding drinks. However, conventional heat insulation bottles or thermos flasks are simply designed to provide an accommodation chamber and a bottle cover for keeping drinks warm. These conventional heat insulation bottle or thermos flask designs are not practical for holding different types of hot and cold drinks. When serving drinks that contain solid matters, the user normally needs to adjust the serving method, to pour the drinks in cups, to use a large straw, or to use a stirrer or other tools, bringing inconvenience.

Conventional heat insulation bottles can simply hold drinks and keep drinks warm, and cannot take into account the actual needs for holding current beverage market drinks such as pearl milk tea, coconut, beverages with fruit particles. Because of the fact that the fruit particles and other slid matters in drinks can deposit on the bottom of the heat insulation bottle or thermos flask. Thus, an additional plastic straw or dip tube must be used, or the drinks must be shaken before service, causing troubles.

Because new drinks have been continuously introduced into the current beverage market, breakthrough neat insulation bottle designs need to be created for holding particle drinks to meet today's social situation with emphasis on environmental protection and green energy, abandoning the non-environmentally friendly cups and drinking containers. Only using new designs of heat insulation bottles or thermos flasks can eliminate the drawbacks of the use of conventional heat insulation bottles or thermos flasks that are inconvenient to use and not practical for holding particular drinks.

### SUMMARY OF THE INVENTION

The present invention has been accomplished under the circumstances in view. It is the main object of the present invention to provide a heat insulation bottle, which can be conveniently converted into different application modes for serving different drinks.

To achieve this and other objects of the present invention, a heat insulation bottle comprises a bottle body, a bottle head, a flexible bushing, and a bottle cover. The bottle body comprises an accommodation chamber opened to a top side thereof. The accommodation chamber defines a concave arc portion in an inner bottom side thereof. The bottle head comprises a bottle mouth located at a top side thereof with an opening defined therein, and a guide surface located at an opposing bottom side thereof. The guide surface slopes upwards from the bottom side of the bottle head to a bottom side of the opening in the bottle mouth. The bottom side of the bottle head is detachably connected to the top side of the bottle body to keep the opening in the bottle mouth in communication with the accommodation chamber. The bottle head further comprises an air vent in communication between the accommodation chamber and the outside. The flexible bushing is mounted in the opening in the bottle mouth. The bottle cover is connected to the bottle head, and adapted for blocking the opening in the bottle mouth.

In one embodiment of the present invention, the heat insulation bottle further comprises a straw having a side opening. The straw is accommodated in the accommodation chamber with one end thereof inserted into the flexible bushing.

In one embodiment of the present invention, the straw has a length longer than the distance between the concave arc portion of the bottle body and the bottom end of the flexible bushing but shorter than the distance between the concave arc portion of the bottle body and the opposing top end of the flexible bushing.

In one embodiment of the present invention, the straw has an outer diameter greater than the inner diameter of the flexible bushing.

In one embodiment of the present invention, the bottle head is composed of a base member and a cap member that is connected to the base member. The base member comprises a connection segment connected to the bottle body, an inner conical segment connected to the connection segment with the guide surface defined therein, and an inner tube segment connected to the inner conical segment opposite to the connection segment. The cap member comprises an outer tube segment attached onto the inner tube segment, and an outer conical segment attached onto the inner conical segment. The inner tube segment and the outer tube segment are composed to create the bottle mouth. The flexible bushing is mounted in the inner tube segment.

Based on the structure described above, the user can use the heat insulation bottle to keep the drinking warm (or cold), and can also select to use or not to use the straw. When serving hot drinks, the user can select not to use the straw, facilitating drinking and avoiding burning to the mouth; when serving cold drinks or drinks with fruit particles or other solid matters, the user can select to use the straw, facilitating absorbing drinks and fruit particles or other solid matters. Thus, the invention achieves multi-purpose, safe, health and environmental protection applications. Further, the design of the concave arc portion of the accommodation chamber of the bottle body and the design of the inner conical segment of the bottle head enable the straw to be kept in the lowest area of the accommodation chamber and automatically aligned in the connection position for best service without adjustment, facilitating the service of the heat insulation bottle.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a heat insulation bottle in accordance with the present invention.

FIG. 2 is an exploded view of the heat insulation bottle in accordance with the present invention.

FIG. 3 is a sectional view of an upper part of the heat insulation bottle in accordance with the present invention.

FIG. 4 is a sectional view of the present invention, illustrating a status of the heat insulation bottle before connection of the straw to the flexible bushing.

FIG. 5 corresponds to FIG. 4, illustrating the straw connected the flexible bushing.

### DETAILED DESCRIPTION OF THE INVENTION

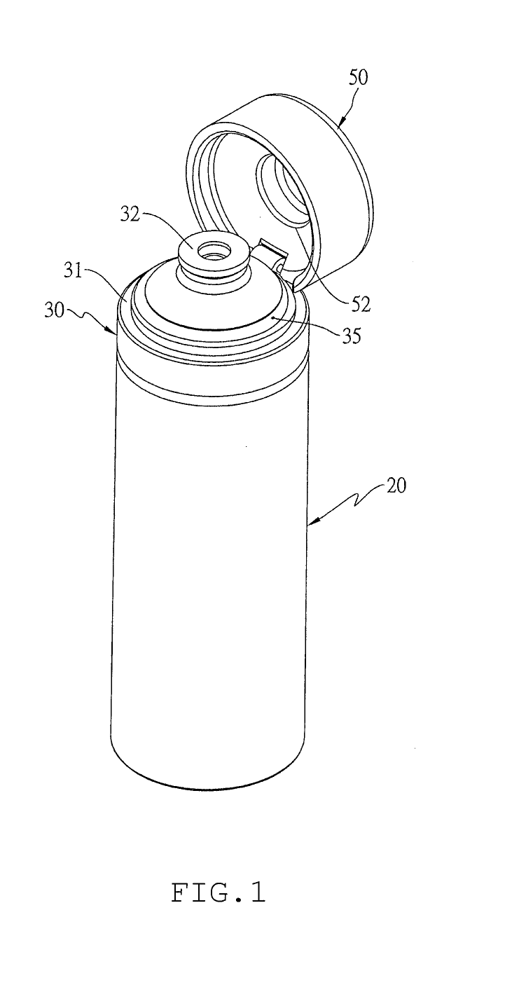

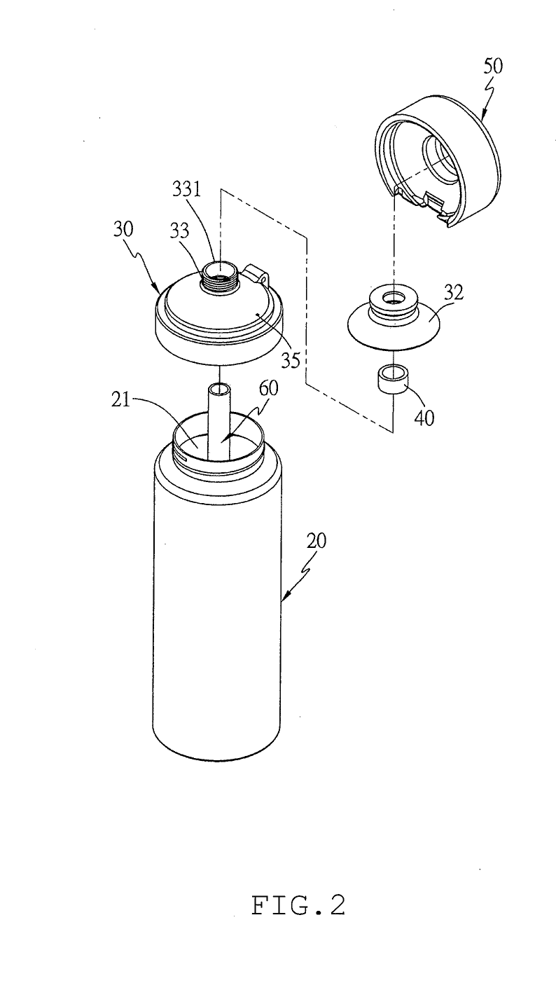

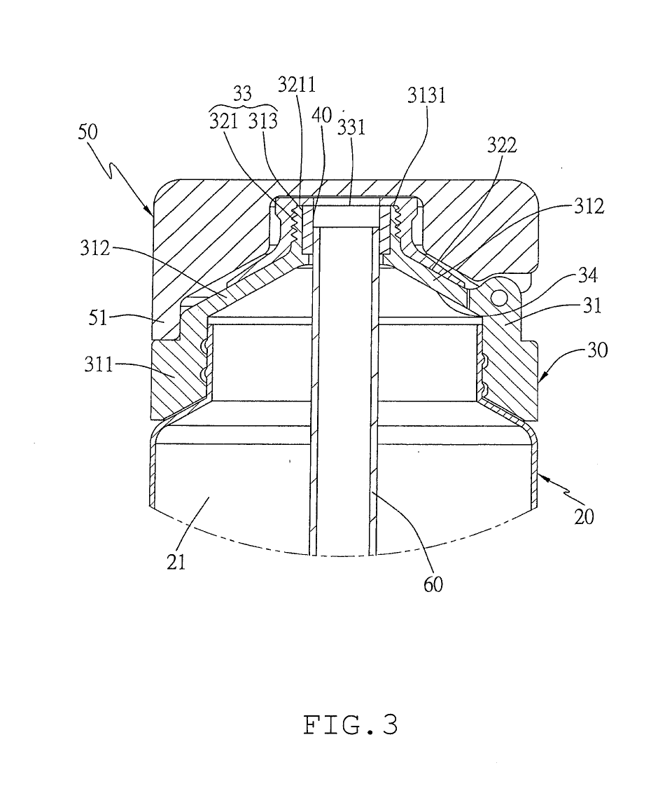

Referring to FIGS. 1-3, a heat insulation bottle in accordance with the present invention is shown. The heat insulation bottle comprises a bottle body 20, a bottle head 30, a flexible bushing 40, a bottle cover 50 and a straw 60.

The bottle body 20 is made of plastic, metal or glass, defining therein an accommodation chamber 21 and a concave arc portion 22 in a bottom side of the accommodation chamber 21.

The bottle head 30 comprises a bottle mouth 33 located at a top side thereof with an opening 331 therein, a guide surface 34 located at an opposing bottom side thereof. The guide surface 34 slopes upwardly toward a bottom side of the opening 331 of the bottle mouth 33. The bottom side of the bottle head 30 is detachably connected to a top side of the bottle body 20, keeping the opening 331 of the bottle mouth 30 in communication with the accommodation chamber 21. The bottle head 30 further comprises an air vent 35 in communication between the accommodation chamber 21 and the outside. In the present preferred embodiment, the bottle head 30 consists of a base member 31 and a cap member 32. The base member 31 comprises a connection segment 311 detachably connected to the bottle body 20, an inner conical segment 312 connected to the connection segment 311 and defining therein the said guide surface 34, and an inner tube segment 313 connected to the inner conical segment 312 opposite to the connection segment 311. The cap member 32 comprises an outer tube segment 321 capped on the inner tube segment 313, and an outer conical segment 322 attached onto the inner conical segment 312. The inner tube segment 313 and the outer tube segment 321 are composed to create the bottle mouth 33. The flexible bushing 40 is accommodated in the inner tube segment 313. The outer tube segment 321 defines an upper wall 3211 at a top side thereof. The upper wall 3211 defines a hole therein at the center. The inner tube segment 313 defines a lower wall 3131 at a top side thereof. The lower wall 3131 defines a hole therein at the center. The diameter of the hole in the upper wall 3211 and the diameter of the hole in the lower wall 3131 are larger than the outer diameter of the flexible bushing 40.

The flexible bushing 40 is made of a flexible material, such as silicon rubber, and mounted in the opening 331 of the bottle mouth 33 with a top end thereof stopped by the upper wall 3211 and the lower wall 3131, and therefore, the flexible bushing 40 is prohibited from falling out of the opening 331 of the bottle mouth 33. After removal of the cap member 32 from the base member 31 through a rotary motion, the user can take the flexible bushing 40 out of the bottle mouth 33 for cleaning or replacement.

The bottle cover 50 is fastened to the bottle head 30 to block the opening 331 of the bottle mouth 33. In the present preferred embodiment, the bottle cover 50 is a snap bottle cover design, having one end thereof pivotally connected to the bottle head 30 and an opposite end thereof terminating in a fastener 51 for fastening the bottle cover 50 to the bottle head 30. The bottle cover 50 defines in an inner top side thereof an annular flange 52 that is detachably attached onto the bottle mouth 33.

In the present preferred embodiment, the straw 60 has a beveled edge 61 at one end thereof, defining therein a side opening. The length of the straw 60 is longer than the distance between the concave arc portion 22 of the bottle body 20 and an opposing bottom end of the flexible bushing 40, but shorter than the distance between the concave arc portion 22 of the bottle body 20 and the top end of the flexible bushing 40, thus, the straw 60 has its one end stopped at the lowest area of the concave arc portion 22 and its other end inserted into the flexible bushing 40.

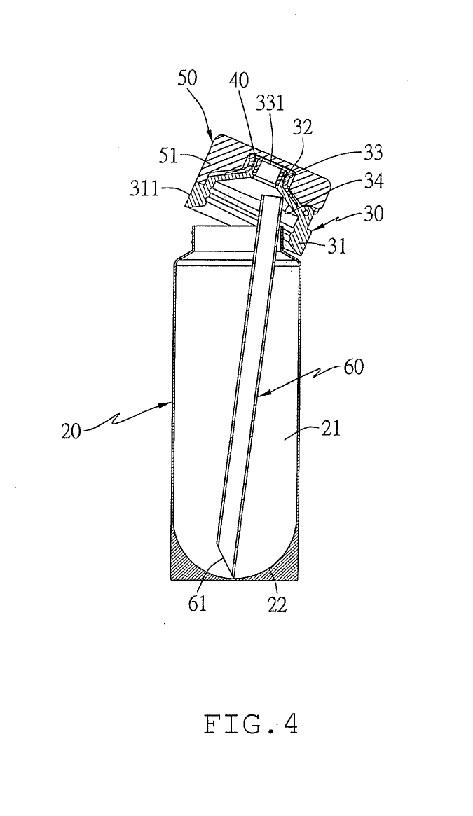

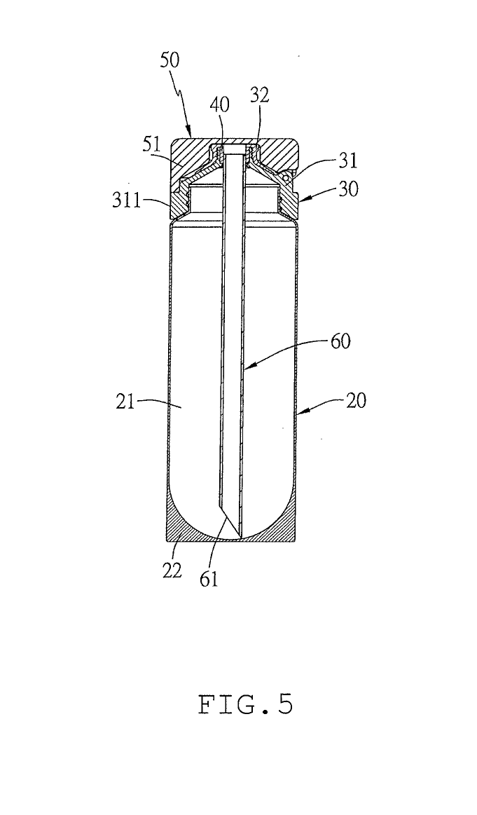

When using the heat insulation bottle, the user can remove the straw 60, and then drink the drinking in the accommodation chamber 21 through the bottle mouth 33. When the user is going to install the straw 60 again, as illustrated in FIG. 4, put the straw 60 in the accommodation chamber 21. Subject to the shape of the concave arc portion 22, one end of the straw 60 will move to the lowest area of the concave arc portion 22. Thereafter, attach the bottle head 30 onto the other end of the straw 60. At this time, the straw 60 will automatically move to the bottle mouth 33 due to the effect of the guide surface 34. Thereafter, fasten tight the bottle head 30, as illustrated in FIG. 5. Since the length of the straw 60 is longer than the distance between the lowest area of the concave arc portion 22 and the bottom end of the flexible bushing 40, the straw 60 will automatically move along the guide surface 34 to the bottle mouth 33 into the flexible bushing 40. At this time, the heat insulation bottle is used as a cold-drink bottle, and the user can drink cold drinking in the bottle body 20 through the bottle mouth 33 and the straw 60.

In general, based on the structure described above, the user can use the heat insulation bottle to keep the drinking warm (or cold), and can also select to use or not to use the straw 60. When serving hot drinks, the user can select not to use the straw 60, facilitating drinking and avoiding burning to the mouth; when serving cold drinks or drinks with fruit particles or other solid matters, the user can select to use the straw 60, facilitating absorbing drinks and fruit particles or other solid matters. Thus, the invention achieves multi-purpose, safe, health and environmental protection applications. Further, the design of the concave arc portion 22 of the accommodation chamber 21 of the bottle body 20 and the design of the inner conical segment 312 of the bottle head 30 enable the straw 60 to be kept in the lowest area of the accommodation chamber 21 and automatically aligned in the connection position for best service without adjustment, facilitating the service of the heat insulation bottle.

What is claimed is:

1. A heat insulation bottle, comprising:
a bottle body comprising an accommodation chamber opened to a top side thereof, said accommodation chamber defining a concave arc portion in an inner bottom side thereof;
a bottle head comprising a bottle mouth located at a top side thereof with an opening defined therein and a guide surface located at an opposing bottom side thereof, said guide surface sloping upwards from the bottom side of said bottle head to a bottom side of the said opening in said bottle mouth, the bottom side of said bottle head being detachably connected to the top side of said bottle body to keep the said opening in said bottle mouth in communication with said accommodation chamber, said bottle head further comprising an air vent in communication between said accommodation chamber and the outside;
a flexible bushing mounted in the said opening in said bottle mouth; and
a bottle cover connected to said bottle head and adapted for blocking the said opening in said bottle mouth.

2. The heat insulation bottle as claimed in claim 1, further comprising a straw having a side opening, said straw being accommodated in said accommodation chamber with one end thereof inserted into said flexible bushing.

3. The heat insulation bottle as claimed in claim 2, wherein said straw has a length longer than the distance between said concave arc portion of said bottle body and a bottom end of said flexible bushing but shorter than the distance between said concave arc portion of said bottle body and an opposing top end of said flexible bushing.

4. The heat insulation bottle as claimed in claim 2, wherein said straw has an outer diameter greater than the inner diameter of said flexible bushing.

5. The heat insulation bottle as claimed in claim 1, wherein said bottle head is composed of a base member and a cap member that is connected to said base member, said base member comprising a connection segment connected to said bottle body, an inner conical segment connected to said connection segment with said guide surface defined therein and an inner tube segment connected to said inner conical segment opposite to said connection segment, said cap member comprising an outer tube segment attached onto said inner tube segment and an outer conical segment attached onto said inner conical segment, said inner tube segment and said outer tube segment being composed to create said bottle mouth, said flexible bushing being mounted in said inner tube segment.

6. The heat insulation bottle as claimed in claim 1, wherein said outer tube segment defines an upper wall at a top side thereof, said upper wall defining an opening at the center thereof; said inner tube segment defines a lower wall at a top side thereof, said lower wall defining an opening at the center thereof, the opening in said upper wall and the opening in said lower wall being greater than the outer diameter of said flexible bushing.
